(19) United States
(12) Patent Application Publication
(10) Pub. No.: US 2025/0068299 A1
(43) Pub. Date: Feb. 27, 2025

(54) METHOD FOR DISPLAYING COMMENT INFORMATION, ELECTRONIC DEVICE, AND STORAGE MEDIUM

(71) Applicant: Beijing Youzhuju Network Technology Co., Ltd., Beijing (CN)

(72) Inventors: Lili LI, Beijing (CN); Zheng ZHOU, Beijing (CN); Yulan ZHANG, Beijing (CN)

(21) Appl. No.: 18/814,338

(22) Filed: Aug. 23, 2024

(30) Foreign Application Priority Data
Aug. 24, 2023 (CN) 202311075877.2

(51) Int. Cl. G06F 3/0482; G06F 40/166

(52) U.S. Cl. CPC G06F 3/0482; G06F 40/166; G06F 2203/04803

(57) ABSTRACT

A method for displaying comment information, an electronic device and a storage medium are provided. The method includes: displaying an object commenting interface, wherein a comment selection area is displayed on the object commenting interface, and an attribute dimension information of the object and a plurality of attribute comment tags corresponding to the attribute dimension information are displayed in the comment selection area; determining a target attribute comment tag, and displaying a preset comment information corresponding to the target attribute comment tag in an information input area of the object commenting interface in response to an triggering action to an attribute comment tag.

This application claims the priority to and benefits of the Chinese Patent Application, No. 202311075877.2, which was filed on Aug. 24, 2023, which is hereby incorporated by reference in its entirety.

### TECHNICAL FIELD

Embodiments of the present disclosure relate to the field of internet technologies, and in particular, to a method for displaying comment information, an electronic device and a storage medium.

### BACKGROUND

With the development of internet technologies, more and more consumers choose to buy goods on internet platforms. After purchasing products, consumer makes comment on the products for being viewed or referred to by other consumers.

In the prior art, a user makes comment on a product through an object commenting interface. An information input area is displayed on the object commenting interface, and the user inputs comment information corresponding to the product in the information input area and then click the submit button to complete commenting on the product.

However, the inventor found that at least the following technical problems exist in the prior art: because the user manually inputs the comment information corresponding to the product when commenting on the product, which requires long time, the above method has poor commenting efficiency.

### SUMMARY

The embodiments of the present disclosure provide a method for displaying comment information, an electronic device and a storage medium, which can improve the input efficiency of the comment information, thereby improving the commenting efficiency.

In first aspect, the embodiments of the present disclosure provides a method for displaying comment information, comprising:
displaying an object commenting interface, wherein a comment selection area is displayed on the object commenting interface, and an attribute dimension information of the object and a plurality of attribute comment tags corresponding to the attribute dimension information are displayed in the comment selection area; and
determining a target attribute comment tag and displaying a preset comment information corresponding to the target attribute comment tag in an information input area of the object commenting interface, in response to a triggering action for an attribute comment tag.

In second aspect, the embodiments of the present disclosure provides an electronic device, comprising:
a processor, and a storage communicatively connected to the processor, the storage stores a computed-executed instruction;
the processor executes the computed-executed instruction stored in the storage to implement the method for displaying comment information in the first aspect.

In third aspect, the embodiments of the present disclosure provides a computer-readable storage medium with a computer-executed instruction stored thereon, wherein the computer-executed instruction, when being executed by a processor, implements the method for displaying comment information in the first aspect.

The embodiments provide a method, an apparatus, a device and a storage medium for displaying comment information, where the method includes: displaying an object commenting interface, where a comment selection area is displayed on the object commenting interface, and an attribute dimension information of the object and a plurality of attribute comment tags corresponding to the attribute dimension information are displayed in the comment selection area; in response to a triggering action to an attribute comment tag, determining a target attribute comment tag, and displaying a preset comment information corresponding to the target attribute comment tag in the information input area of the object commenting interface. Because when a user writes comment information, the attribute dimension information of the object and a plurality of attribute comment tags corresponding to the attribute dimension information can be displayed to provide the user with selectable information for commenting on the object, so that the user may determine the comment information rapidly. In addition, when the user triggers the attribute comment tag, a preset comment information corresponding to the attribute comment tag can be displayed, and the preset comment information is automatically generated and does not require manual input from the user, thereby improving the input efficiency of the comment information.

### BRIEF DESCRIPTION OF DRAWINGS

In order to more clearly illustrate the embodiments of the present disclosure or the technical solutions in the prior art, the following provides a brief introduction to the drawings to be used in the description of the embodiments or the prior art. It is apparent that the drawings described below illustrate some embodiments of the present disclosure, and those skilled in the art may obtain other drawings according to these drawings without creative labor.

FIG. 1 is a schematic diagram of an application scenario for a method for displaying comment information provided in an embodiment of the present disclosure;

FIG. 2 is a flow chart of a method for displaying comment information provided in an embodiment of the present disclosure;

FIG. 3 is a schematic diagram of an object commenting interface provided in an embodiment of the present disclosure;

FIG. 4A, FIG. 4B, and FIG. 4C provide schematic diagrams of an object commenting interface provided in embodiments of the present disclosure;

FIG. 5 is a schematic diagram of an object commenting interface provided in an embodiment of the present disclosure;

FIG. 6 is a flow chart of another method for displaying comment information provided in an embodiment of the present disclosure;

FIG. 7 is a schematic diagram of a comment list interface provided in an embodiment of the present disclosure;

FIG. 8 is a structural block diagram of an apparatus for displaying comment information provided in an embodiment of the present disclosure; and

FIG. 9 is a hardware structural schematic diagram of an electronic device provided in an embodiment of the present disclosure.

### DETAILED DESCRIPTION

In order to make the objectives, technical solutions, and advantages of the embodiments of the present disclosure clearer, the technical solutions in the embodiments of the present disclosure are described clearly and completely below with reference to the accompanying drawings in the embodiments of the present disclosure. It is apparent that the described embodiments are not exhaustive, but part of the embodiments of the present disclosure. Based on the embodiments of the present disclosure, all other embodiments obtained by those of ordinary skill in the art without creative work shall fall within the protection scope of the present disclosure.

With the development of internet technologies, more and more consumers choose to buy goods on internet platforms. After purchasing products, consumer can comment on the products for view and reference of other consumers.

In the prior art, a user comments on a product through an object commenting interface. An information input area is displayed on the object commenting interface, and the user inputs comment information corresponding to the product in the information input area and then click the submit button to complete commenting on the product. However, because the user manually inputs the comment information corresponding to the product when commenting on the product, which requires long time, the above method has poor commenting efficiency.

It can be seen that a technical problem that needs to be solved urgently is to quickly input comment information to improve the comment efficiency of the product.

In order to solve the above problems, the following technical concept are proposed. Firstly, an object comment interface is displayed, herein, a comment selection area is displayed on the object comment interface, and the attribute dimension information of the object and a plurality of attribute comment tags corresponding to the attribute dimension information are displayed in the comment selection area. In this way, when a user writes comment information, the attribute dimension information of the object and the plurality of attribute comment tags corresponding to the attribute dimension information can be displayed to provide the user with selectable information for commenting on the object, so that the user can quickly determine the comment information. Then, in response to a triggering action for the attribute comment tag, a target attribute comment tag is determined, and preset comment information corresponding to the target attribute comment tag is displayed in the information input area of the object commenting interface. When the user triggers the attribute comment tag, a preset comment information corresponding to the attribute comment tag can be displayed, and the preset comment information is automatically generated and does not require manual input from the user, thereby improving the input efficiency of the comment information.

The following explains an application scenario for the method provided in an embodiment of the present disclosure.

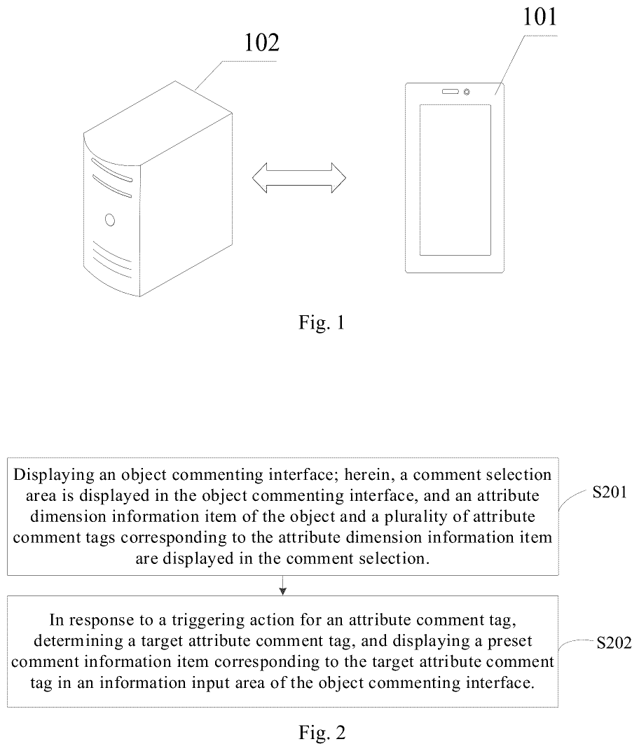

The method for displaying comment information provided in an embodiment of the present disclosure may be applied to an application scenario for commenting on various objects. FIG. 1 is a schematic diagram of an application scenario for a method for displaying comment information provided in an embodiment of the present disclosure. As shown in FIG. 1, a server 102 and a terminal device 101 are connected in a wired or wireless way. Exemplarily, the object is a product A, and the terminal device 101 obtains preset comment information of the user for the product A through the method for displaying comment information provided in the embodiment of the present disclosure. The terminal device 101 sends a request for publishing the comment information to the server 102. The publishing request contains a preset comment of the user for the product A. The server 102 publishes the preset comment information of the product, in response to receive the publishing request. In this case, the user and other users can view the preset comment information of the product A through the internet platform. The following uses a detailed embodiment to describe the method of displaying comment information provided in the embodiments of the present disclosure in detail.

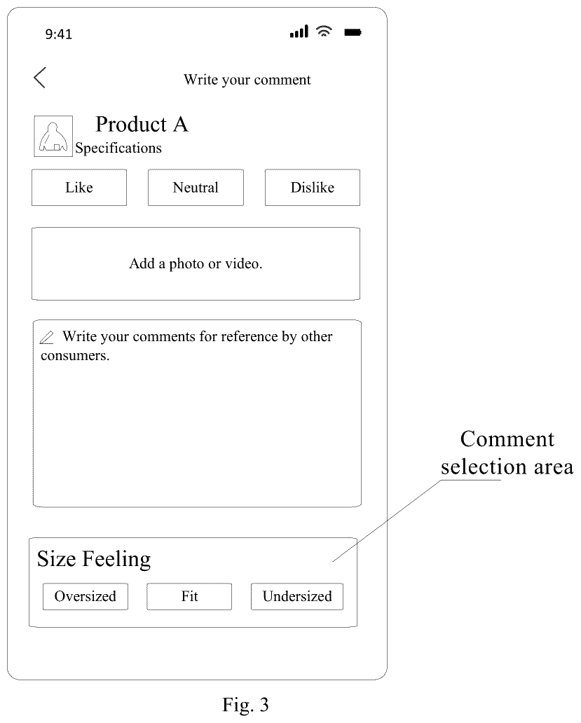

Referring to FIG. 2, a flow chart of a method for displaying comment information provided in an embodiment of the present disclosure is shown. The present embodiment is described by using a terminal device as an example of an implementation subject. The method includes:

Step S201: displaying an object commenting interface; herein, a comment selection area is displayed on the object commenting interface, and an attribute dimension information of the object and a plurality of attribute comment tags corresponding to the attribute dimension information are displayed in the comment selection area.

In one embodiment of the present disclosure, the object commenting interface is a commenting interface for any object. The object may be a physical item, such as: clothing, cosmetics, and the like. It may also be a non-physical item, such as a body massage service, a software service, a consulting service, or the like.

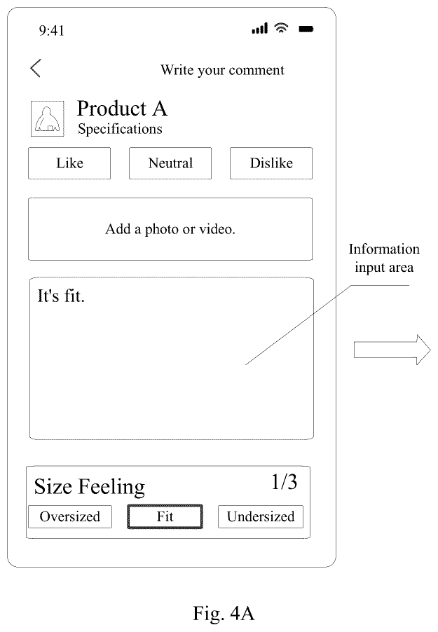

In the embodiments of the present disclosure, the position of the comment selection area in the object commenting interface is not specifically limited, and the comment selection area may be located at the top, middle, or bottom of the object commenting interface. Exemplarily, as shown in FIG. 3, the comment selection area is located at the bottom of the object commenting interface.

The attribute dimension information is used to represent an attribute category of the attribute information of an object, and the attribute comment tags are used to represent specific attribute information under an attribute category. For example, the object is a garment, and the attribute dimension information of the object may be: the “Size Feeling” of the garment, the “Fabric Thickness” of the garment, and the “Style for look slim or not” of the garment. The plurality attribute comment tags corresponding to the “Size Feeling” can include: “Oversized”, “Fit”, and “Undersized”; the plurality of attribute comment tags corresponding to “Fabric Thickness” may include: “Thick”, “Moderate”, “Thin”; and the plurality of attribute comment tags corresponding to “Style for look slim or not” may include: “Looking slim”, “Normal”, and “Not looking slim”.

It should be noted that there may be one or more attribute dimension information of an object. Optionally, if the object has a plurality of attribute dimension information, one of the plurality of attribute dimension information may be displayed in the comment selection area. The plurality of attribute dimension information may be switched to display individual attribute dimension information in the comment selection area.

In one embodiment of the present disclosure, the plurality of attribute dimension information may be displayed in a preset display order. Accordingly, the steps of switching between the plurality attribute dimension information include: taking the first attribute dimension information in the plurality of attribute dimension information as the target attribute dimension information based on the preset display order, and displaying the target attribute dimension information and a plurality of attribute comment tags corresponding to the target attribute dimension information in the comment selection area; if the target attribute dimension information is not the last attribute dimension information in the plurality of attribute dimension information, taking the next attribute dimension information of the target attribute dimension information as the target attribute dimension information, and repeating the step of displaying the target attribute dimension information and the plurality of attribute comment tags corresponding to the target attribute dimension information in the comment selection area, in response to a triggering action for the attribute comment tag of the target attribute dimension information; if the target attribute dimension information is the last attribute dimension information in the plurality of attribute dimension information, closing the comment selection area in response to a triggering action of the attribute comment tag of the target attribute dimension information.

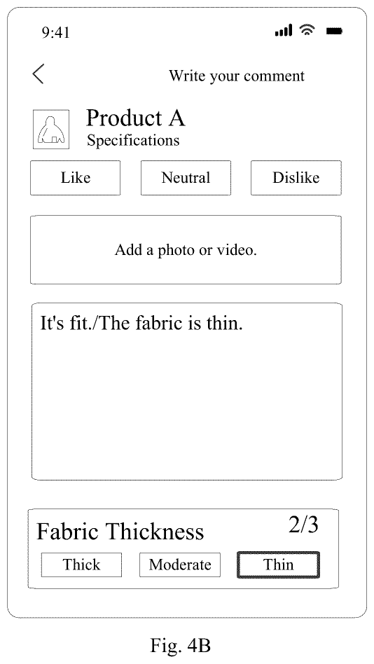

Exemplarily, as shown in FIG. 4A to FIG. 4C, the plurality of attribute dimensions include: “Size Feeling”, “Fabric Thickness”, and “Style for look slim?”. In the preset display order, the first attribute dimension information is “Size Feeling”, the second attribute dimension information is “Fabric Thickness”, and the third attribute dimension information is “Style for look slim?”.

In this case, the plurality of attribute dimension information may be switched as below:

According to the preset display order, the first attribute dimension information “Size Feeling” in the plurality of attribute dimension information is used as the target attribute dimension information, and the target attribute dimension information “Size Feeling” and a plurality of attribute comment tags corresponding to “Size Feeling” are displayed in the comment selection area: “Oversized”, “Fit”, and “Undersized”; if the target attribute dimension information is not the last attribute dimension information in the plurality of attribute dimension information, the next attribute dimension information “Fabric Thickness” of the target attribute dimension information “Size Feeling” is used as the target attribute dimension information, in response to the triggering action for the attribute comment tag (for example, “fit”) of the target attribute dimension information “Size Feeling”, and the target attribute dimension information “Fabric Thickness” and a plurality of attribute comment tags corresponding to “Fabric Thickness” are displayed in the comment selection area.

If the target attribute dimension information “Fabric Thickness” is not the last attribute dimension information in the plurality of attribute dimension information, the next attribute dimension information “Style for look slim?” of the target attribute dimension information “Fabric Thickness” is used as the target attribute dimension information, and the target attribute dimension information “Style for look slim” and a plurality of attribute comment tags corresponding to “Style for look slim” are displayed in the comment selection area, in response to the triggering action for the attribute comment tag (for example, “thin”) of the target attribute dimension information “Fabric Thickness”.

The target attribute dimension information “Style for look slim?” is the last attribute dimension information in the plurality of attribute dimension information, the comment selection area is closed, in response to the triggering action for the target attribute dimension information “Style for look slim?” (for example, “Looking slim”).

In one embodiment of the present disclosure, the user can also actively switch between the plurality of attribute dimension information through a preset operation. For example, it is implemented through the following steps:
in response to a first switching operation for the attribute dimension information currently displayed in the comment selection area, displaying a next attribute dimension information of the attribute dimension information currently displayed and a plurality of attribute comment tags corresponding to the next attribute dimension information according to the preset display order; and/or, in response to a second switching operation for the attribute dimension information currently displayed in the comment selection area, displaying a previous attribute dimension information of the attribute dimension information currently displayed and a plurality of attribute comment tags corresponding to the previous attribute dimension information according to the preset display order.

The first preset action may be any one of the specified actions, and the second preset action may be any one of the specified actions. Optionally, for example, the first preset action is a swiping to the right and the second preset action is a swiping to the left.

Exemplarily, the second attribute dimension “Fabric Thickness” and a plurality of corresponding attribute comment tags: “Thick”, “Moderate”, “Thin” are currently displayed. In response to the operation of swiping to the right on the comment selection area, the third attribute dimension information “Style for look slim” and a plurality of corresponding attribute comment tags “Look slim”, “Normal”, and “Not look slim” are displayed. In response to the operation of swiping to the left on the comment selection area, the first attribute dimension information “Size Feeling” and a plurality of corresponding attribute comment tags “Oversized”, “Fit”, and “Undersized” are displayed.

It should be noted that in response to the first preset action on the comment selection area (such as the operation of swiping to the right), if the attribute dimension information currently displayed is the last attribute dimension information, the switching is not displayed. In response to the second preset action on the comment selection area (such as the operation of swiping to the left), if the attribute dimension information currently displayed is the first attribute dimension information, the switching is not displayed.

In one embodiment of the present disclosure, when the object has a plurality of attribute dimension information, the quantity of attribute dimension information and the serial number of the attribute dimension information currently displayed in the display order are displayed in the comment selection area. Optionally, the serial number is next to the quantity, and a preset spacing character is displayed between the serial number and the quantity. Optionally, still referring to FIG. 4A to FIG. 4C, the serial number “1” is on the left of the quantity, and a preset spacing character “/” is displayed between the serial number and the quantity.

In one embodiment of the present disclosure, when an object has a plurality of attribute dimension information, the plurality of attribute dimension information may also be automatically switched. For example, it is implemented through the following steps: in response to that the display duration of the attribute dimension information currently displayed in the comment selection area reaches a preset display duration, a next attribute dimension information of the attribute dimension information currently displayed and a plurality of attribute comment tags corresponding to the next attribute dimension information according to the preset display order are displayed. In the embodiment of the present disclosure, the value of the preset display duration is not specifically limited. For example, the preset display duration may be 10 seconds, 20 seconds, or 30 seconds.

In one embodiment of the present disclosure, demand information corresponding to attribute dimension information is displayed in the comment selection area, herein, the demand information is used to represent the quantity of users who pay attention to the attribute dimension information.

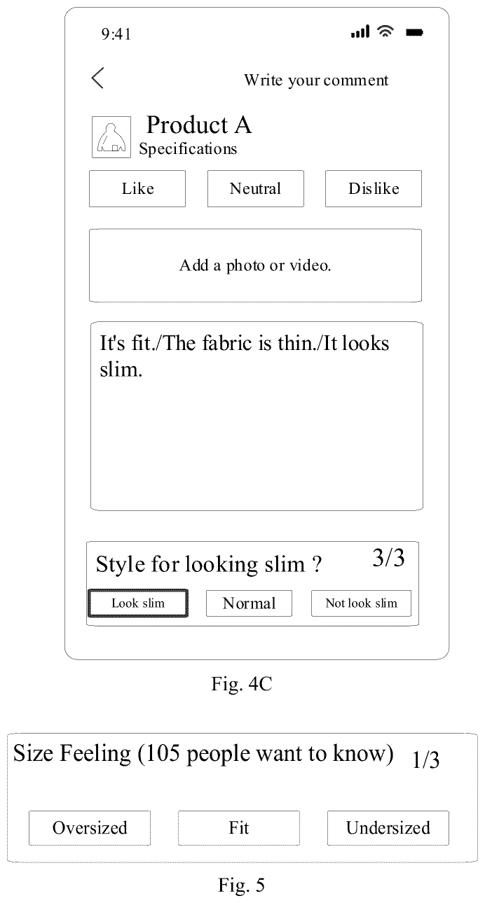

Optionally, the demand information corresponding to the attribute dimension information may be on a side of the attribute dimension information. For example, as shown in FIG. 5, the demand information corresponding to the attribute dimension information “Size Feeling” may be “105 people want to know”, and the demand information “105 people want to know” is located on the right of the attribute dimension information “Size Feeling”.

Step S202: In response to a triggering action for an attribute comment tag, determining a target attribute comment tag, and displaying a preset comment information corresponding to the target attribute comment tag in an information input area of the object commenting interface.

In one embodiment of the present disclosure, the correspondence relationship between an attribute dimension information, an attribute comment tag and a preset comment information are stored in advance. Accordingly, before displaying the preset comment information corresponding to the target attribute comment tag in the information input area of the object commenting interface, the method further includes: based on the target attribute comment tag and the attribute dimension information, determining the preset comment information associated with the target attribute comment tag and the attribute dimension information from the stored correspondence relationship between the attribute dimension information, the attribute comment tag and the preset comment information.

For example, the preset comment information corresponding to the attribute dimension information “Size Feeling” and the attribute comment tag “Oversized” is: “It's oversized.” The preset comment information corresponding to the attribute dimension information “Size Feeling” and the attribute comment tag “Fit” is: “It's fit.” The preset comment information corresponding to the attribute dimension information “Size Feeling” and the attribute comment tag “Undersized” is: “It's undersized.”

In one embodiment of the present disclosure, the preset comment information includes the attribute dimension information and the target attribute comment tag under the attribute dimension information. For example, continuing with FIG. 4A to FIG. 4C, in response to the triggering action for the target attribute comment tag “Fit”, the preset comment information “It's fit.” is displayed in the information input area. In this case, the preset comment information corresponding to “Size Feeling” is: “It's fit.” (including the attribute dimension information “Size Feeling” and the target attribute comment tag “Fit”).

For another example, in response to the triggering action for the target attribute comment tag “Thin”, the preset comment information “The fabric is thin.” is displayed in the information input area. In this case, the preset comment information corresponding to “Fabric Thickness” is: “The fabric is thin.” (including the attribute dimension information “Fabric Thickness” and the target attribute comment tag “Thin”).

For yet another example, in response to the triggering action for the target attribute comment tag “Look slim”, the preset comment information “It looks slim.” is displayed in the information input area. In this case, the preset comment information corresponding to “Style for look slim?” is: “It looks slim.” (including the attribute dimension information “Style for look slim?” and the target attribute comment tag “Look slim”).

The embodiments provide a method for displaying comment information, and the method includes: displaying an object commenting interface, herein, a comment selection area is displayed on the object commenting interface, and an attribute dimension information of the object and a plurality of attribute comment tags corresponding to the attribute dimension information are displayed in the comment selection area; in response to a triggering action to an attribute comment tag, determining a target attribute comment tag and displaying a preset comment information corresponding to the target attribute comment tag in an information input area of the object commenting interface. When a user writes comment information, the attribute dimension information of the object and a plurality of attribute comment tags corresponding to the attribute dimension information are displayed to provide the user with selectable information for commenting on the object, so that the user can determine the comment information rapidly. In addition, when the user triggers the attribute comment tag, a preset comment information corresponding to the attribute comment tag are displayed, and the preset comment information is automatically generated and does not require manual input from the user, thereby improving the input efficiency of the comment information.

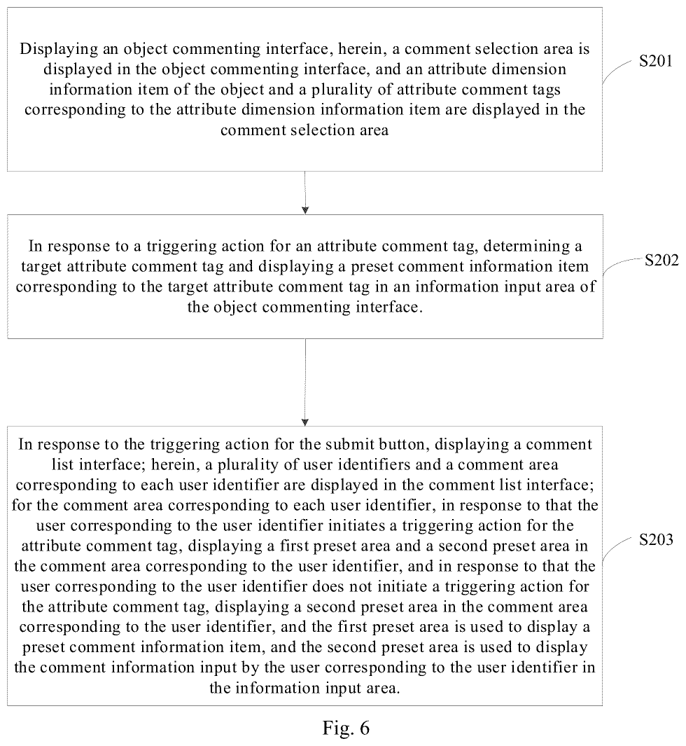

FIG. 6 is a flow chart of another method for displaying comment information provided in an embodiment of the present disclosure. In the embodiment of the present disclosure, a submit button for the comment information is displayed on the object commenting interface, and the user can submit the corresponding preset comment information through the submit button. As shown in FIG. 6, after the step S202, the method further includes:

Step S203: in response to the triggering action for the submit button, displaying a comment list interface; herein, a plurality of user identifiers and a comment area corresponding to each user identifier are displayed on the comment list interface; for the comment area corresponding to each user identifier, if the user corresponding to the user identifier initiates a triggering action for the attribute comment tag, displaying a first preset area and a second preset area in the comment area corresponding to the user identifier; and if the user corresponding to the user identifier does not initiate a triggering action for the attribute comment tag, displaying a second preset area in the comment area corresponding to the user identifier; the first preset area is used to display a preset comment information, and the second preset area is used to display the comment information input by the user corresponding to the user identifier in the information input area.

In one embodiment of the present disclosure, the first preset area and the second preset area may be located at any position in the comment area. The second preset area is adjacent to and on a side of the first preset area. Optionally, for example, the first preset area may be a title area, which is at the top of the comment area.

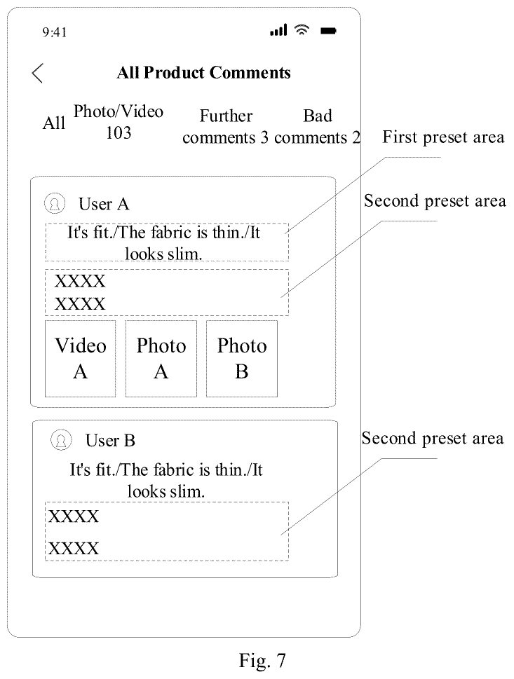

For example, as shown in FIG. 7, a first preset area and a second preset area are displayed in the comment area corresponding to a user A. Herein, the first preset area may be a title area located at the top of the comment area; the preset comment information in the title area is: It's fit./The fabric is thin/It looks slim. The second preset area is located below the first preset area, and the second preset area displays the comment information input by the user A in the information input area. A second preset area is displayed in comment area corresponding to the user B, and the second preset area displays the comment information input by the user B in the information input area.

It should be noted that in order to highlight the preset comment information, the font, font style, font size, and the like of the preset comment information may be set separately. For example, as shown in FIG. 7, font of the preset comment information (It's fit./The fabric is thin./It looks slim.) may be set as bold.

Here, because the preset comment information is displayed separately in a preset area of the comment area to attract attention of the user, the user may obtain the preset comment information corresponding to the product apparently, and the preset comment information includes an attribute dimension information and a target attribute comment tag under the attribute dimension information, which displays the characteristics of the object concisely, thereby improving the effectiveness of the comment information.

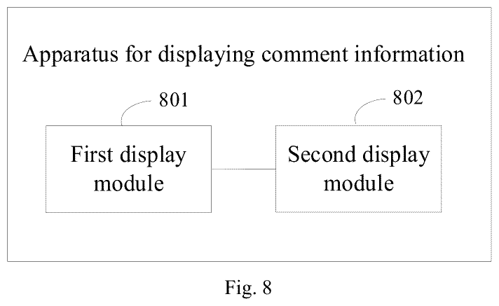

FIG. 8 is a structural block diagram of an apparatus for displaying comment information provided in an embodiment of the present disclosure. Referring to FIG. 8, the apparatus includes: a first display module 801 and a second display module 802.

The first display module 801 is configured to display an object commenting interface, herein, a comment selection area is displayed on the object commenting interface, and an attribute dimension information of the object and a plurality of attribute comment tags corresponding to the attribute dimension information are displayed in the comment selection area.

The second display module 802 is configured to, in response to a triggering action for the attribute comment tag, determine a target attribute comment tag and display a preset comment information corresponding to the target attribute comment tag in an information input area of the object commenting interface

According to one or more embodiments of the present disclosure, there are a plurality of attribute dimension information, the first display module 801 is further configured to: take the first attribute dimension information in the plurality of attribute dimension information as the target attribute dimension information based on the preset display order, and display the target attribute dimension information and a plurality of attribute comment tags corresponding to the target attribute dimension information in the comment selection area; if the target attribute dimension information is not the last attribute dimension information in the plurality of attribute dimension information, in response to a triggering action for the attribute comment tag of the target attribute dimension information item, the next attribute dimension information of the target attribute dimension information is taken as the target attribute dimension information, and the step of displaying the target attribute dimension information and the plurality of attribute comment tags corresponding to the target attribute dimension information in the comment selection area is repeated; if the target attribute dimension information is the last attribute dimension information in the plurality of attribute dimension information, in response to a triggering action for the attribute comment tag of the target attribute dimension information item, the comment selection area is closed.

According to one or more embodiments of the present disclosure, the first display module 801 is further configured to: display a next attribute dimension information of the attribute dimension information currently displayed and a plurality of attribute comment tags corresponding to the next attribute dimension information according to the preset display order, in response to a first switching operation for the attribute dimension information currently displayed in the comment selection area; and/or, display a previous attribute dimension information of the attribute dimension information currently displayed and a plurality of attribute comment tags corresponding to the previous attribute dimension information according to the preset display order, in response to a second switching operation for the attribute dimension information currently displayed in the comment selection area.

According to one or more embodiments of the present disclosure, the first display module 801 is further configured to display the quantity of attribute dimension information in the comment selection area and the serial number of the attribute dimension information currently displayed in the display order; herein, the serial number is located on a side of the quantity, and a preset spacing character is displayed between the serial number and the quantity.

According to one or more embodiments of the present disclosure, the object has a plurality of attribute dimension information, the first display module is further configured to: display a next attribute dimension information of the attribute dimension information currently displayed and a plurality of attribute comment tags corresponding to the next attribute dimension information according to the preset display order, in response to that the display duration of the attribute dimension information currently displayed in the comment selection area reaches a preset display duration.

According to one or more embodiments of the present disclosure, the attribute dimension information is configured to indicate an attribute category to which the attribute information of the object belongs, the attribute comment tag is configured to indicate specific attribute information under the attribute category; the preset comment information includes an attribute dimension information and a target attribute comment tag under the attribute dimension information. Accordingly, the apparatus further includes: a determining module, the determining module is configured to determine the preset comment information associated with the target attribute comment tag and the attribute dimension information from the stored correspondence relationship between an attribute dimension information, an attribute comment tag and a preset comment information, based on the target attribute comment tag and the attribute dimension information.

According to one or embodiments of the present disclosure, demand information corresponding to attribute dimension information is displayed in the comment selection area, herein, the demand information is used to represent the quantity of users who pay attention to the attribute dimension information.

According to one or embodiments of the present disclosure, a submit button of the comment information is displayed on the object commenting interface. Accordingly, the apparatus further includes: a third display module, the third display module is configured to display a comment list interface in response to the triggering action for the submit button; herein, a plurality of user identifiers and a comment area corresponding to each user identifier are displayed on the comment list interface. For the comment area corresponding to each user identifier, if the user corresponding to the user identifier initiates a triggering action for the attribute comment tag, a first preset area and a second preset area are displayed in the comment area corresponding to the user identifier; if the user corresponding to the user identifier does not initiate a triggering action for the attribute comment tag, a second preset area is displayed in the comment area corresponding to the user identifier; the first preset area is used to display a preset comment information, and the second preset area is used to display the comment information input by the user corresponding to the user identifier in the information input area.

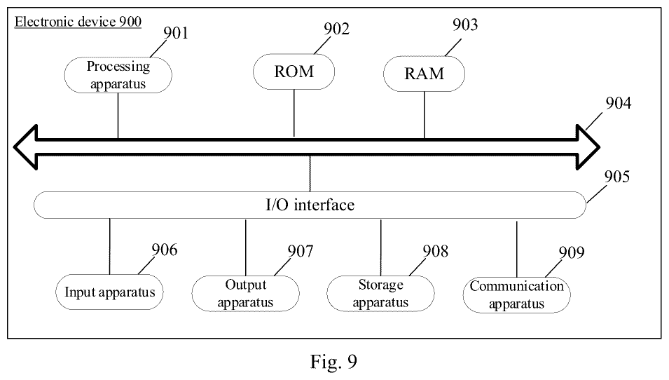

Referring to FIG. 5, a schematic structural diagram of an electronic device 900 suitable for implementing the embodiments of the present disclosure is shown. The electronic device 900 may be a terminal device or a server. The terminal device includes but is not limited to a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 9 is merely an example, and should not pose any limitation to the functions and the range of use of the embodiments of the present disclosure.

As illustrated in FIG. 9, the electronic device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected by means of a bus 904. An input/output (I/O) interface 905 is also connected to the bus 904.

Usually, the following apparatus may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 9 illustrates the electronic device 900 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flow charts may be implemented as a computer software program. For example, some embodiments of the present disclosure include a computer program product, which includes a computer program carried by a non-transitory computer-readable medium. The computer program includes program codes for performing the methods shown in the flow charts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the method provided by the embodiments of the present application.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flow charts and block diagrams in the accompanying drawings illustrate the architecture, functionality, and operation of possible implementations of systems, methods, and computer program products according to various embodiments of the present disclosure. In this regard, each block in the flow charts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flow charts, and combinations of blocks in the block diagrams and/or flow charts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In a first aspect, according to one or more embodiments of the present disclosure, a method for displaying comment information is provided, where the method includes:
displaying an object commenting interface, wherein a comment selection area is displayed on the object commenting interface, and an attribute dimension information of the object and a plurality of attribute comment tags corresponding to the attribute dimension information are displayed in the comment selection area; and
determining a target attribute comment tag and displaying a preset comment information corresponding to the target attribute comment tag in an information input area of the object commenting interface, in response to a triggering action for an attribute comment tag.

According to one or more embodiments of the present disclosure, the object has a plurality of attribute dimension information, the method further includes:
taking a first attribute dimension information in the plurality of attribute dimension information as the target attribute dimension information according to a preset display order, and displaying the target attribute dimension information and a plurality of attribute comment tags corresponding to the target attribute dimension information in the comment selection area;
if the target attribute dimension information is not the last attribute dimension information in the plurality of attribute dimension information, taking the next attribute dimension information of the target attribute dimension information as the target attribute dimension information, and repeating the step of displaying the target attribute dimension information and a plurality of attribute comment tags corresponding to the target attribute dimension information in the comment selection area, in response to a triggering action to the attribute comment tag for the target attribute dimension information; and
if the target attribute dimension information is the last attribute dimension information in the plurality of attribute dimension information, closing the comment selection area, in response to a triggering action to an attribute comment tag for the target attribute dimension information.

According to one or more embodiments of the present disclosure, the method further includes:
displaying a next attribute dimension information of the attribute dimension information currently displayed and a plurality of attribute comment tags corresponding to the next attribute dimension information according to a preset display order, in response to a first switching action for the attribute dimension currently displayed in the comment selection area; and/or,
displaying a previous attribute dimension information of the attribute dimension information currently displayed and a plurality of attribute comment tags corresponding to the previous attribute dimension information according to a preset display order, in response to a second switching action for the attribute dimension currently displayed in the comment selection area.

According to one or more embodiments of the present disclosure, the method further includes: displaying a quantity of attribute dimension information and a serial number of the attribute dimension information currently displayed in the display order in the comment selection area; wherein the serial number is at a side of the quantity, and a preset spacing character is displayed between the serial number and the quantity.

According to one or more embodiments of the present disclosure, the object has a plurality of attribute dimension information, the method further includes: displaying a next attribute dimension information of the attribute dimension information currently displayed and a plurality of attribute comment tags corresponding to the next attribute dimension information according to the preset display order, in response to that a display duration of the attribute dimension information currently displayed in the comment selection area reaches a preset display duration.

According to one or more embodiments of the present disclosure, the attribute dimension information is configured to indicate an attribute category to which the attribute information of the object belongs; the attribute comment tag is configured to indicate specific attribute information under an attribute category; the preset comment information comprises an attribute dimension information and a target attribute comment tag under the attribute dimension information; wherein before the displaying a preset comment information corresponding to the target attribute comment tag in an information input area of the object commenting interface, the method further comprises: determining the preset comment information associated with the target attribute comment tag and the attribute dimension information from a stored correspondence relationship between an attribute dimension information, an attribute comment tag and a preset comment information, based on the target attribute comment tag and the attribute dimension information.

According to one or more embodiments of the present disclosure, demand information corresponding to attribute dimension information is displayed in the comment selection area, the demand information is used to represent a quantity of users who pay attention to the attribute dimension information.

According to one or more embodiments of the present disclosure, a submit button of the comment information is displayed on the object commenting interface; wherein the method further comprises: displaying a comment list interface in response to a triggering action to the submit button; wherein a plurality of user identifiers and a comment area corresponding to each user identifier are displayed on the comment list interface.

In a second aspect, according to one or more embodiments of the present disclosure, an apparatus for displaying comment information is provided, where the apparatus includes:
a first display module, configured to display an object commenting interface, wherein a comment selection area is displayed on the object commenting interface, and an attribute dimension information of the object and a plurality of attribute comment tags corresponding to the attribute dimension information are displayed in the comment selection area; and
a second display module, configured to, determine a target attribute comment tag, and display a preset comment information corresponding to the target attribute comment tag in an information input area of the object commenting interface, in response to a triggering action for the attribute comment tag.

According to one or more embodiments of the present disclosure, the object has a plurality of attribute dimension information, and the first display module is further configured for: taking a first attribute dimension information in the plurality of attribute dimension information as the target attribute dimension information according to a preset display order, and displaying the target attribute dimension information and a plurality of attribute comment tags corresponding to the target attribute dimension information in the comment selection area; if the target attribute dimension information is not the last attribute dimension information in the plurality of attribute dimension information, taking the next attribute dimension information of the target attribute dimension information as the target attribute dimension information, and repeating the step of displaying the target attribute dimension information and a plurality of attribute comment tags corresponding to the target attribute dimension information in the comment selection area, in response to a triggering action to the attribute comment tag for the target attribute dimension information; and if the target attribute dimension information is the last attribute dimension information in the plurality of attribute dimension information, closing the comment selection area, in response to a triggering action to an attribute comment tag for the target attribute dimension information.

According to one or more embodiments of the present disclosure, the first display module is further configured for: displaying a next attribute dimension information of the attribute dimension information currently displayed and a plurality of attribute comment tags corresponding to the next attribute dimension information according to a preset display order, in response to a first switching action for the attribute dimension currently displayed in the comment selection area; and/or, displaying a previous attribute dimension information of the attribute dimension information currently displayed and a plurality of attribute comment tags corresponding to the previous attribute dimension information according to a preset display order, in response to a second switching action for the attribute dimension currently displayed in the comment selection area.

According to one or more embodiments of the present disclosure, the first display module is further configured for displaying a quantity of attribute dimension information and a serial number of the attribute dimension information currently displayed in the display order in the comment selection area; wherein the serial number is at a side of the quantity, and a preset spacing character is displayed between the serial number and the quantity.

According to one or more embodiments of the present disclosure, the object has a plurality of attribute dimension information, the first display module is further configured for displaying a next attribute dimension information of the attribute dimension information currently displayed and a plurality of attribute comment tags corresponding to the next attribute dimension information according to the preset display order, in response to that a display duration of the attribute dimension information currently displayed in the comment selection area reaches a preset display duration.

According to one or more embodiments of the present disclosure, the attribute dimension information is configured for indicate an attribute category to which the attribute information of the object belongs; the attribute comment tag is configured to indicate specific attribute information under an attribute category; the preset comment information comprises an attribute dimension information and a target attribute comment tag under the attribute dimension information. Accordingly, the apparatus further includes: a determining module, the determining module is configured to determine the preset comment information associated with the target attribute comment tag and the attribute dimension information from a stored correspondence relationship between an attribute dimension information, an attribute comment tag and a preset comment information, based on the target attribute comment tag and the attribute dimension information.

According to one or embodiments of the present disclosure, demand information corresponding to attribute dimension information is displayed in the comment selection area, the demand information is used to represent a quantity of users who pay attention to the attribute dimension information.

According to one or embodiments of the present disclosure, a submit button of the comment information is displayed on the object commenting interface. Accordingly, the apparatus further includes: a third display module, the third display module is configured to display a comment list interface in response to a triggering action to the submit button; wherein a plurality of user identifiers and a comment area corresponding to each user identifier are displayed on the comment list interface. For the comment area corresponding to each user identifier, the third display module is configured for: displaying a first preset area and a second preset area in the comment area corresponding to the user identifier, if the user corresponding to the user identifier initiates a triggering action for the attribute comment tag; displaying a second preset area in the comment area corresponding to the user identifier, if the user corresponding to the user identifier does not initiate a triggering action for the attribute comment tag

In a third aspect, according to one or more embodiments of the present disclosure, an electronic device is provided, including: a processor and a storage communicatively connected to the processor;
the storage stores a computed-executed instruction; and
the processor executes a computer execution instruction stored in the storage to implement the method for displaying comment information described in the first aspect and various possible designs of the first aspect above.

In a fourth aspect, according to one or more embodiments of the present disclosure, a computer-readable storage medium with a computer-executed instruction stored thereon is provided, the computer-executed instruction, when being executed by a processor, implements the method for displaying comment information described in the first aspect and various possible designs of the first aspect above.

In a fifth aspect, the embodiments of the present disclosure provides a computer program product including a computer program that, when being executed by a processor, implements the method for displaying comment information described in the first aspect and various possible designs of the first aspect above.

The above only describe preferred embodiments of the present disclosure and the technical principles used. Those skilled in the art should understand that the scope of disclosure involved in the present disclosure is not limited to the technical solutions formed by the specific combination of the above-mentioned technical features, but shall also cover other technical solutions formed by any combination of the above-mentioned technical features or their equivalent features without departing from the above-mentioned disclosure concept. For example, a technical solution formed by replacing the above-mentioned features with (but not limited to) technical features with similar functions disclosed in the present disclosure.

In addition, while operations are depicted in a specific order, this should not be construed as requiring them to be performed in the specific order in which they are shown or in a sequential order. In some context, multitasking and parallel processing can be beneficial. Similarly, although a number of specific implementation details are included in the above discussion, these should not be construed as limiting the scope of the present disclosure. Some features described in the context of individual embodiments may also be implemented in combination in a single embodiment. In contrast, the various features described in the context of a single embodiment may also be implemented in multiple embodiments individually or in any suitable sub-combination of embodiments.

Although the subject matter has been described in a language specific to the structural features and/or logical actions of the method, it should be understood that the subject matter defined in the claims is not necessarily limited to the specific features or actions described above. Instead, the specific features and actions described above are only exemplary forms of implementing the claims.

1. A method for displaying comment information, comprising:
displaying an object commenting interface, wherein a comment selection area is displayed on the object commenting interface, and an attribute dimension information of the object and a plurality of attribute comment tags corresponding to the attribute dimension information are displayed in the comment selection area; and
determining a target attribute comment tag and displaying a preset comment information corresponding to the target attribute comment tag in an information input area of the object commenting interface, in response to a triggering action for an attribute comment tag.

2. The method according to claim 1, wherein the object has a plurality of attribute dimension information, the method further comprises:
taking a first attribute dimension information in the plurality of attribute dimension information as the target attribute dimension information according to a preset display order, and displaying the target attribute dimension information and a plurality of attribute comment tags corresponding to the target attribute dimension information in the comment selection area;
if the target attribute dimension information is not the last attribute dimension information in the plurality of attribute dimension information, taking the next attribute dimension information of the target attribute dimension information as the target attribute dimension information, and repeating the step of displaying the target attribute dimension information and a plurality of attribute comment tags corresponding to the target attribute dimension information in the comment selection area, in response to a triggering action to the attribute comment tag for the target attribute dimension information; and
if the target attribute dimension information is the last attribute dimension information in the plurality of attribute dimension information, closing the comment selection area, in response to a triggering action to an attribute comment tag for the target attribute dimension information.

3. The method according to claim 2, further comprising:
displaying a next attribute dimension information of the attribute dimension information currently displayed and a plurality of attribute comment tags corresponding to the next attribute dimension information according to a preset display order, in response to a first switching action for the attribute dimension currently displayed in the comment selection area; and/or,
displaying a previous attribute dimension information of the attribute dimension information currently displayed and a plurality of attribute comment tags corresponding to the previous attribute dimension information according to a preset display order, in response to a second switching action for the attribute dimension currently displayed in the comment selection area.

4. The method according to claim 2, further comprising:
displaying a quantity of attribute dimension information and a serial number of the attribute dimension information currently displayed in the display order in the comment selection area;
wherein the serial number is at a side of the quantity, and a preset spacing character is displayed between the serial number and the quantity.

5. The method according to claim 1, wherein the object has a plurality of attribute dimension information, the method further comprises:
displaying a next attribute dimension information of the attribute dimension information currently displayed and a plurality of attribute comment tags corresponding to the next attribute dimension information according to the preset display order, in response to that a display duration of the attribute dimension information currently displayed in the comment selection area reaches a preset display duration.

6. The method according to claim 1, wherein,
the attribute dimension information is configured to indicate an attribute category to which the attribute information of the object belongs;
the attribute comment tag is configured to indicate specific attribute information under an attribute category;
the preset comment information comprises an attribute dimension information and a target attribute comment tag under the attribute dimension information;
wherein before the displaying a preset comment information corresponding to the target attribute comment tag in an information input area of the object commenting interface, the method further comprises:
determining the preset comment information associated with the target attribute comment tag and the attribute dimension information from a stored correspondence relationship between an attribute dimension information, an attribute comment tag and a preset comment information, based on the target attribute comment tag and the attribute dimension information.

7. The method according to claim 1, wherein demand information corresponding to attribute dimension information is displayed in the comment selection area, the demand information is used to represent a quantity of users who pay attention to the attribute dimension information.

8. The method according to claim 1, wherein:
a submit button of the comment information is displayed on the object commenting interface;
wherein the method further comprises:
displaying a comment list interface in response to a triggering action to the submit button; wherein a plurality of user identifiers and a comment area corresponding to each user identifier are displayed on the comment list interface.

9. The method according to claim 8, wherein for the comment area corresponding to each user identifier, the method further comprises:
displaying a first preset area and a second preset area in the comment area corresponding to the user identifier, if the user corresponding to the user identifier initiates a triggering action for the attribute comment tag;
displaying a second preset area in the comment area corresponding to the user identifier, if the user corresponding to the user identifier does not initiate a triggering action for the attribute comment tag,
wherein the first preset area is used to display a preset comment information, and the second preset area is used to display the comment information input by the user corresponding to the user identifier in the information input area.

10. The method according to claim 2, wherein,
the attribute dimension information is configured to indicate an attribute category to which the attribute information of the object belongs;
the attribute comment tag is configured to indicate specific attribute information under an attribute category;
the preset comment information comprises an attribute dimension information and a target attribute comment tag under the attribute dimension information;
wherein before the displaying a preset comment information corresponding to the target attribute comment tag in an information input area of the object commenting interface, the method further comprises:
determining the preset comment information associated with the target attribute comment tag and the attribute dimension information from a stored correspondence relationship between an attribute dimension information, an attribute comment tag and a preset comment information, based on the target attribute comment tag and the attribute dimension information.

11. The method according to claim 2, wherein demand information corresponding to attribute dimension information is displayed in the comment selection area, the demand information is used to represent a quantity of users who pay attention to the attribute dimension information.

12. The method according to claim 2, wherein:
a submit button of the comment information is displayed on the object commenting interface;
wherein the method further comprises:
displaying a comment list interface in response to a triggering action to the submit button; wherein a plurality of user identifiers and a comment area corresponding to each user identifier are displayed on the comment list interface.

13. The method according to claim 12, wherein for the comment area corresponding to each user identifier, the method further comprises:
displaying a first preset area and a second preset area in the comment area corresponding to the user identifier, if the user corresponding to the user identifier initiates a triggering action for the attribute comment tag;
displaying a second preset area in the comment area corresponding to the user identifier, if the user corresponding to the user identifier does not initiate a triggering action for the attribute comment tag,
wherein the first preset area is used to display a preset comment information, and the second preset area is used to display the comment information input by the user corresponding to the user identifier in the information input area.

14. The method according to claim 3, wherein,
the attribute dimension information is configured to indicate an attribute category to which the attribute information of the object belongs;
the attribute comment tag is configured to indicate specific attribute information under an attribute category;
the preset comment information comprises an attribute dimension information and a target attribute comment tag under the attribute dimension information;
wherein before the displaying a preset comment information corresponding to the target attribute comment tag in an information input area of the object commenting interface, the method further comprises:
determining the preset comment information associated with the target attribute comment tag and the attribute dimension information from a stored correspondence relationship between an attribute dimension information, an attribute comment tag and a preset comment information, based on the target attribute comment tag and the attribute dimension information.

15. The method according to claim 3, wherein demand information corresponding to attribute dimension information is displayed in the comment selection area, the demand information is used to represent a quantity of users who pay attention to the attribute dimension information.

16. The method according to claim 3, wherein:
a submit button of the comment information is displayed on the object commenting interface;
wherein the method further comprises:
displaying a comment list interface in response to a triggering action to the submit button; wherein a plurality of user identifiers and a comment area corresponding to each user identifier are displayed on the comment list interface.

17. The method according to claim 16, wherein for the comment area corresponding to each user identifier, the method further comprises:
displaying a first preset area and a second preset area in the comment area corresponding to the user identifier, if the user corresponding to the user identifier initiates a triggering action for the attribute comment tag;
displaying a second preset area in the comment area corresponding to the user identifier, if the user corresponding to the user identifier does not initiate a triggering action for the attribute comment tag,
wherein the first preset area is used to display a preset comment information, and the second preset area is used to display the comment information input by the user corresponding to the user identifier in the information input area.

18. The method according to claim 4, wherein,
the attribute dimension information is configured to indicate an attribute category to which the attribute information of the object belongs;
the attribute comment tag is configured to indicate specific attribute information under an attribute category;
the preset comment information comprises an attribute dimension information and a target attribute comment tag under the attribute dimension information;
wherein before the displaying a preset comment information corresponding to the target attribute comment tag in an information input area of the object commenting interface, the method further comprises:
determining the preset comment information associated with the target attribute comment tag and the attribute dimension information from a stored correspondence relationship between an attribute dimension information, an attribute comment tag and a preset comment information, based on the target attribute comment tag and the attribute dimension information.

19. An electronic device, comprising:
a processor, and
a storage communicatively connected to the processor, wherein the storage stores a computed-executed instruction;
wherein the processor executes the computed-executed instruction stored in the storage to implement a method for displaying comment information, the method comprising:
displaying an object commenting interface, wherein a comment selection area is displayed on the object commenting interface, and an attribute dimension information of the object and a plurality of attribute comment tags corresponding to the attribute dimension information are displayed in the comment selection area; and
determining a target attribute comment tag and displaying a preset comment information corresponding to the target attribute comment tag in an information input area of the object commenting interface, in response to a triggering action for an attribute comment tag.

20. A computer-readable storage medium with a computer-executed instruction stored thereon, wherein the computer-executed instruction, when being executed by a processor, implements a method for displaying comment information, the method comprising:
displaying an object commenting interface, wherein a comment selection area is displayed on the object commenting interface, and an attribute dimension information of the object and a plurality of attribute comment tags corresponding to the attribute dimension information are displayed in the comment selection area; and
determining a target attribute comment tag and displaying a preset comment information corresponding to the target attribute comment tag in an information input area of the object commenting interface, in response to a triggering action for an attribute comment tag.
